(19) United States
(12) Patent Application Publication
(10) Pub. No.: US 2005/0094641 A1
(43) Pub. Date: May 5, 2005

(54) Apparatus, method, and medium for fast connection to link layer and network layer in a network system

(75) Inventors: Won-dong Yun, Seoul (KR); Soo-hong Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/975,383

(22) Filed: Oct. 29, 2004

(30) Foreign Application Priority Data
Oct. 30, 2003 (KR) 2003-76414

(51) Int. Cl. H04Q 7/24

(52) U.S. Cl. 370/395.2; 370/352; 370/401

(57) ABSTRACT

An apparatus, method, and medium for connection to a link layer and a network layer of a wireless LAN. The link/network layer access method may include transmitting a request message requesting information for connecting a mobile node and the network layer of a wireless LAN before connection of the mobile node and the link layer of the wireless LAN is completed, and completing connection to the network layer by using information included in a response message, transmitted in response to the transmitted request message. Accordingly, by concurrently processing the process for connecting to the link layer and to the network layer of the wireless LAN, a high speed handover in the wireless LAN can be achieved.

### CROSS-REFERENCE TO RELATED APPLICATIONS

This application claims the priority benefit of Korean Patent Application No. 2003-76414, filed on Oct. 30, 2003, in the Korean Intellectual Property Office, the disclosure of which is incorporated herein in its entirety by reference.

### BACKGROUND OF THE INVENTION

1. Field of the Invention

The present invention relates to a handover in a wireless local area network (LAN), and more particularly, to an apparatus, method, and medium for connecting to a link layer and a network layer of a wireless LAN.

2. Description of the Related Art

Conventionally, in a wireless LAN environment, when a mobile node (MN) moves, at high speed, from one wireless LAN to another wireless LAN, a link layer handover is first performed and then a network layer handover is performed. In order to perform the network layer handover, the transmitting and receiving of a router solicitation message, and the transmitting and receiving of a router advertisement message can be performed only after the link layer handover is completed.

Thus, conventionally, since the link layer handover and the network layer handover should be performed sequentially, this becomes a limiting factor for implementation of fast handovers. Accordingly, when a provided handover speed cannot support the moving speed of a mobile node, a connection being performed can be cut off and packets may be lost.

### SUMMARY OF THE INVENTION

Embodiments of the present invention set forth apparatuses, media, and methods enabling concurrent processing of a link layer handover and a network layer handover in a network system.

Additional aspects and/or advantages of the invention will be set forth in part in the description which follows and, in part, will be obvious from the description, or may be learned by practice of the invention.

To achieve the above and/or other aspects and advantages, embodiments of the present invention set forth a link layer/network layer access method, including transmitting a request message requesting information for connecting a mobile node and a network layer of a wireless LAN before completion of a connection of the mobile node and a link layer of the wireless LAN, and completing connection of the mobile node to the network layer by using information included in a response message, transmitted in response to the transmitted request message.

Unlike a router request solicitation message of an Internet Protocol version 6 (IPv6) standard which is capable of being requested only after the connection to the link layer is completed, the request message is capable of being requested before connection to the link layer is completed, and the response message is a router advertisement message of the IPv6 standard.

In addition, if the transmitted request message is received, transmitting a response message including information for connection to the network layer, receiving the transmitted response message and transferring the received response message to the mobile node, and completing connection to the network layer based on information included in the transmitted response message.

The method may further include transmitting a request frame requesting information for connection to the link layer, wherein in the transmitting of the request message requesting information for connecting a mobile node and the network layer, if the transmitted request frame is received, the request message is transmitted.

In the transmitting of the request message requesting information for connecting a mobile node and the network layer a response frame, to the request message and the request frame, is transmitted, and in completing connection to the network layer, by using information included in the transmitted response frame, connection to the link layer is completed and the response message is received.

The request frame is an association request frame of an IEEE 802.11 standard, and the response frame is an association response frame of the IEEE 802.11 standard.

To achieve the above and/or other aspects and advantages, embodiments of the present invention set forth a link layer/network layer access apparatus, including an access point transmitting a request message requesting information for connecting a mobile node and a network layer of a wireless LAN, before connection of the mobile node and a link layer of the wireless LAN is completed, and the mobile node completing connection to the network layer by using information included in a response message to the transmitted request message.

To achieve the above and/or other aspects and advantages, embodiments of the present invention set forth a relay method, including transmitting a request message requesting information for connection of a mobile node to a network layer of the wireless LAN if a request frame, requesting information for connecting a mobile node and a link layer of a wireless LAN, is received, and receiving a response message to the transmitted request message, and transmitting the received response message to the mobile node.

To achieve the above and/or other aspects and advantages, embodiments of the present invention set forth an access point, including a request message transmission unit to, if a request frame requesting information for connecting a mobile node and a link layer of a wireless LAN is received, transmit a request message requesting information for connection to a network layer of the wireless LAN, and a response message relay unit to receive a response message to the request message transmitted by the request message transmission unit, and transmit the received response message to the mobile node.

To achieve the above and/or other aspects and advantages, embodiments of the present invention set forth a routing method, including receiving a request message from an access point requesting information for connecting a mobile node and a network layer of a wireless LAN, and transmitting a response message, to the received request message, to the mobile node through the access point, wherein the response message is transmitted from an access router before connection between the mobile node and a link layer of the wireless LAN is completed.

To achieve the above and/or other aspects and advantages, embodiments of the present invention set forth an access router, including a request message reception unit to receive a request message from an access point requesting information for connecting a mobile node and a network layer of a wireless LAN, and a router advertisement message transmission unit to transmit a response message, to the request message received by the request message reception unit, to the mobile node through the access point, wherein the response message is transmitted from the access router before connection between the mobile node and the link layer of the wireless LAN is completed.

The access router may communicate with the access point through a wired network, and the access point and the mobile unit communicate through a wireless network.

To achieve the above and/or other aspects and advantages, embodiments of the present invention set forth a computer readable medium including computer readable code for a link layer/network layer access method, wherein the method includes transmitting a request message requesting information for connecting a mobile node and a network layer of a wireless LAN before connection of the mobile node and the link layer of a wireless LAN is completed, and completing connection of the mobile node to the network layer by using information included in a response message, transmitted in response to the transmitted request message.

To achieve the above and/or other aspects and advantages, embodiments of the present invention set forth a computer readable medium including computer readable code for a relay method, wherein the method includes transmitting a request message requesting information for connection of a mobile node to a network layer of the wireless LAN if a request frame requesting information for connecting the mobile node and a link layer of a wireless LAN is received, and receiving a response message to the transmitted request message, and transmitting the received response message to the mobile node.

To achieve the above and/or other aspects and advantages, embodiments of the present invention set forth a computer readable medium including computer readable code for a routing method, wherein the method includes receiving a request message from an access point requesting information for connecting a mobile node and a network layer of a wireless LAN, and transmitting a response message to the received request message, to the mobile node through the access point, wherein the response message is transmitted from an access router before connection between the mobile node and the link layer of the wireless LAN is completed.

To achieve the above and/or other aspects and advantages, embodiments of the present invention set forth a mobile node in a wireless network, including a request frame transmission unit transmitting an association request frame requesting information for connecting the mobile node and a network layer of the wireless network, a response frame reception unit to receive an association response frame responding to the association request frame including information for implementing a link layer access with the wireless network, and a response message reception unit to receive a response message including information for implementing a network layer access with the wireless network, such that the response message may be generated and/or sent to the mobile node before implementation of the link layer access.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of an apparatus for fast connection to a link layer/network layer, according to an embodiment of the present invention;

FIG. 2 illustrates a mobile node, an access point, and an access router, shown in FIG. 1, in detail;

FIG. 3 is a flowchart of a method for fast connection to a link layer/network layer, according to an embodiment of the present invention;

FIG. 4 is a flowchart of a method for relaying a wireless LAN and/or a wired network, according to an embodiment of the present invention; and

FIG. 5 is a flowchart of a wired network routing method, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

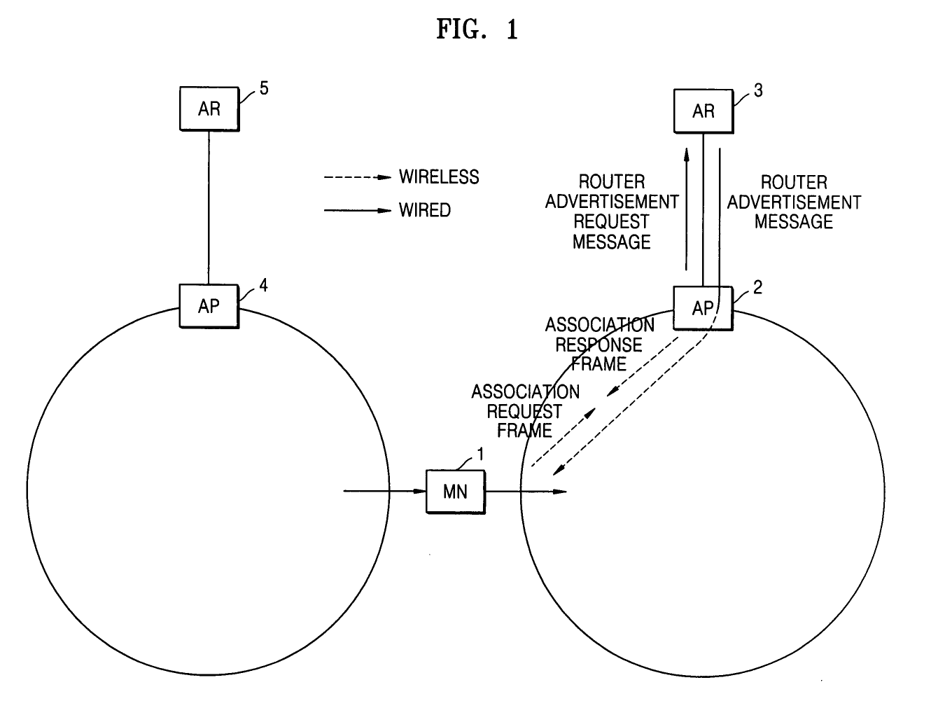

As illustrated in FIG. 1, an apparatus for fast connection to a link layer/network layer, according to an embodiment of the present invention, includes a mobile node (MN) 1, an access point (AP) 2, and an access router (AR) 3.

In this illustration, the mobile node 1 is moving into a wireless LAN managed by the access point 2, from a wireless LAN managed by another access point 4, and trying to connect to the wireless LAN managed by the access point 2.

The mobile node 1 wirelessly transmits an association request frame requesting information for connection to the link layer of the wireless LAN.

In the present embodiment, connection to the link layer is described by using the terminology used in the IEEE 802.11 standard, but can be described by using other terminology. A mobile node complying with Mobile Internet Protocol version 6 (IPv6) can also be referred to as a station according to the IEEE 802.11 standard. Though these names may be different, they all correspond to a host moving on a wireless LAN. Further, the association request frame contains mainly information on the capabilities of a mobile node.

If the association request frame transmitted by the mobile node 1 is received by access point 2, the access point 2 transmits a router advertisement request message, to the access router 3, requesting information for connection to the network layer of the wireless LAN and an association response frame, to mobile node 1, containing information for connection to the link layer of the wireless LAN.

Conventionally, if an association request frame is received, an association response frame will be transmitted, and after connection to the link layer is completed, connection to the network layer will then be tried. However, in the present embodiment, if an association request frame is received, a router advertisement request message, which is a message for trying to establish a connection to the network layer, and an association response frame are transmitted at the same time. Accordingly, the process for connection to the link layer and the process for connection to the network layer can be performed concurrently and a fast handover can be implemented.

In the present embodiment, connection to the network layer is described by using terminology used in the Mobile IPv6, but can be described by using other terminology.

According to the present embodiment, completing connection to the network layer means that the mobile node 1, having moved into the new wireless LAN, allows itself to be recognized to the outside, and this corresponds with the Mobile IPv6 standard. That is, it means that the mobile node 1 has generated a network layer address, which is a new recognition mark. The network layer address is also referred to as care of address (CoA), and is a global address.

Meanwhile, this global address is generated by combining the identification (ID) of the interface of the mobile node 1 and a wireless LAN prefix, as transmitted by the access router 3. Accordingly, in order to generate a global address, the mobile node 1 should receive a router advertisement message, including information for connection to the network layer of the wireless LAN, such as a wireless LAN prefix transmitted from the access router 3. The router advertisement message is transmitted periodically, or when requested.

A router advertisement message transmitted periodically is referred to as an unsolicited router advertisement message and is used mainly by the access router 3 to provide latest information for the wireless LAN managed by the access router 3, to the wireless LAN. Meanwhile, a router advertisement message transmitted when requested is referred to as a solicited router advertisement message and is used mainly when necessary, for example, when the mobile node 1 needs to generate a global address.

According to the present embodiment, the mobile node 1 transmits a router solicitation message to the access router 3, in order to receive a router advertisement message, corresponding with the IPv6 standard. However, the problem in the conventional IPv6 standard is that a router solicitation message can be transmitted only after connection to the link layer is completed.

Accordingly, in the present embodiment, a newly defined router advertisement request message is used, where the access point 2 can request directly a router advertisement message even before the connection to the link layer of the wireless LAN is completed. This router advertisement request message is transferred to the access router 3, from the access point 2, and complies with a light weight access point protocol (LWAPP), which is a communication protocol between the access point 2 and the access router 3.

In the present embodiment, a type of the router advertisement request message is specified as “25,” which is still conventionally reserved for an unassigned type on the LWAPP. Since the router advertisement message, requested by the router advertisement request message, is not requested by a router request message, it is an unsolicited router advertisement message by nature.

The mobile node 1 receives an association response frame transmitted by the access point 2, and by using information included in the received association response message, completes connection to the link layer of the wireless LAN. While the mobile node 1 performs this operation, the access router 3 transmits a router advertisement message, if the access router 3 has received the router advertisement request message transmitted by the access point 2.

When a router advertisement message is transmitted, in response to a router advertisement request message, a plurality of router advertisement messages are not transmitted at the same a time, and therefore a random delay is not required. However, to ensure that the mobile node receives the router advertisement message, the router advertisement message may be transmitted three times in a row, for example. The access point 2 receives the router advertisement message transmitted by the access router 3, and transmits the received router advertisement message.

Accordingly, in a state where connection to the link layer of the wireless LAN is completed, the mobile node 1 receives the router advertisement message, transmitted by the access point 2.

After that time, by using information included in the received router advertisement message, connection to the network layer of the wireless LAN is completed. That is, according to the present embodiment, connection to the link layer and connection to the network layer are almost concurrently performed such that a fast handover can be enabled.

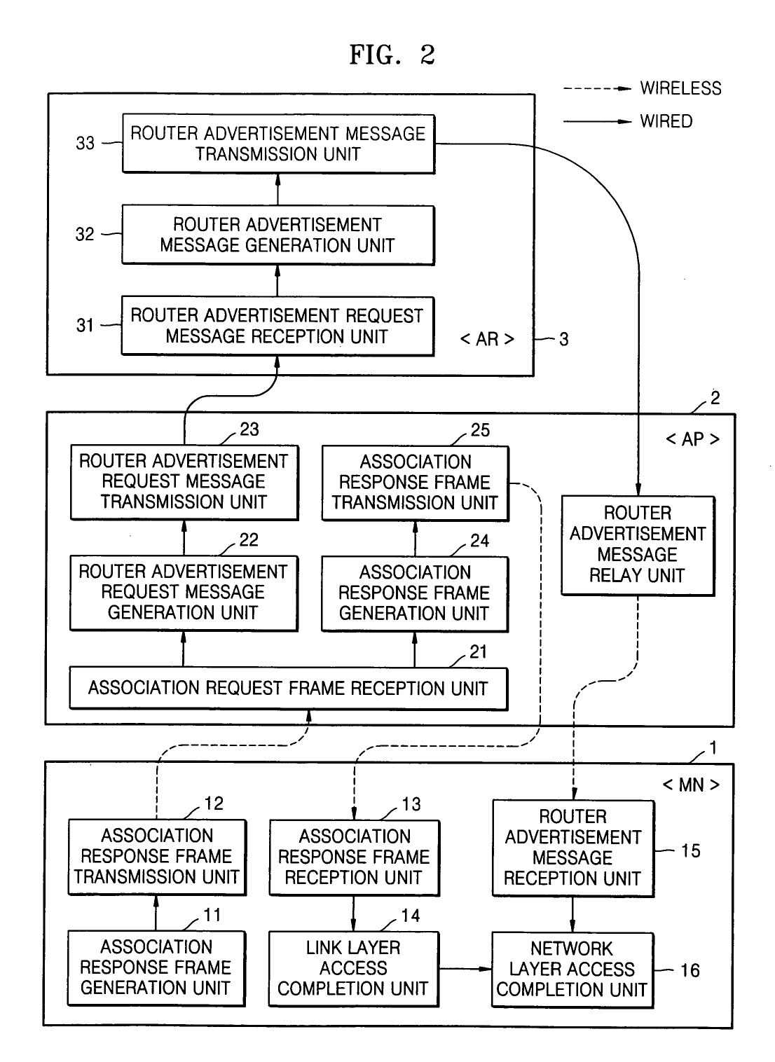

FIG. 2 illustrates, in detail, the mobile node 1, the access point 2, and the access router 3 shown in FIG. 1.

Referring to FIG. 2, the mobile node 1 includes an association request frame generation unit 11, an association request frame transmission unit 12, an association response frame reception unit 13, a link layer connection completion unit 14, a router advertisement message reception unit 15, and a network layer connection completion unit 16. Here, the mobile node 1 is a mobile node trying to establish a connection to a wireless LAN.

The association request frame generation unit 11 generates an association request frame. The association request frame transmission unit 12 transmits the association request frame generated in the association request frame generation unit 11, to the access point 2.

The association response frame reception unit 13 receives an association response frame, which is a response to the association request frame, from the access point 2, which receives the association request frame transmitted by the association request frame transmission unit 12.

The link layer connection completion unit 14 completes connection to the link layer of a wireless LAN by using information included in the association response frame received by the association response frame reception unit 13.

The router advertisement message reception unit 15 receives a router advertisement message on the link layer to which connection is completed in the link layer connection completion unit 14.

The network layer connection completion unit 16 generates an address on the network layer of the wireless LAN by using information included in the router advertisement message received by the router advertisement message reception unit 15, and by doing so, completes connection to the network layer of the wireless LAN.

Referring to FIG. 2, the access point 2 includes an association request frame reception unit 21, a router advertisement request message generation unit 22, a router advertisement request message transmission unit 23, an association response frame generation unit 24, an association response frame transmission unit 25, and a router advertisement message relay unit 26. Here, the access point 2 plays a role of relaying within the wireless LAN and the wired network.

The association request frame reception unit 21 receives an association request frame from the mobile node 1.

If the association request frame is received by the association request frame reception unit 21, the router advertisement request message generation unit 22 generates a router advertisement request message.

The router advertisement request message transmission unit 23 transmits the router advertisement request message generated in the router advertisement request message generation unit, to the access router 3.

If the association request frame is received by the association request frame reception unit 21, the association response frame generation unit 24 generates an association response frame.

The association response frame transmission unit 2 transmits the association response frame generated in the association response frame generation unit 24, to the mobile node 1.

The router advertisement message relay unit 26 receives the router advertisement message from the access router 3, and transmits the received router advertisement message to the mobile node 1.

Referring to FIG. 2, the access router 3 includes a router advertisement request message reception unit 31, a router advertisement message generation unit 32, and a router advertisement message transmission unit 33. Here, the access router 3 is connected to a wired network.

The router advertisement request message reception unit 31 receives a router advertisement request message from the access point 2.

If the router advertisement request message is received by the router advertisement request message reception unit 31, the router advertisement message generation unit 32 generates a router advertisement message.

The router advertisement message transmission unit 33 transmits the router advertisement message, generated in the router advertisement message generation unit 32, to the mobile node 1 through the access point 2.

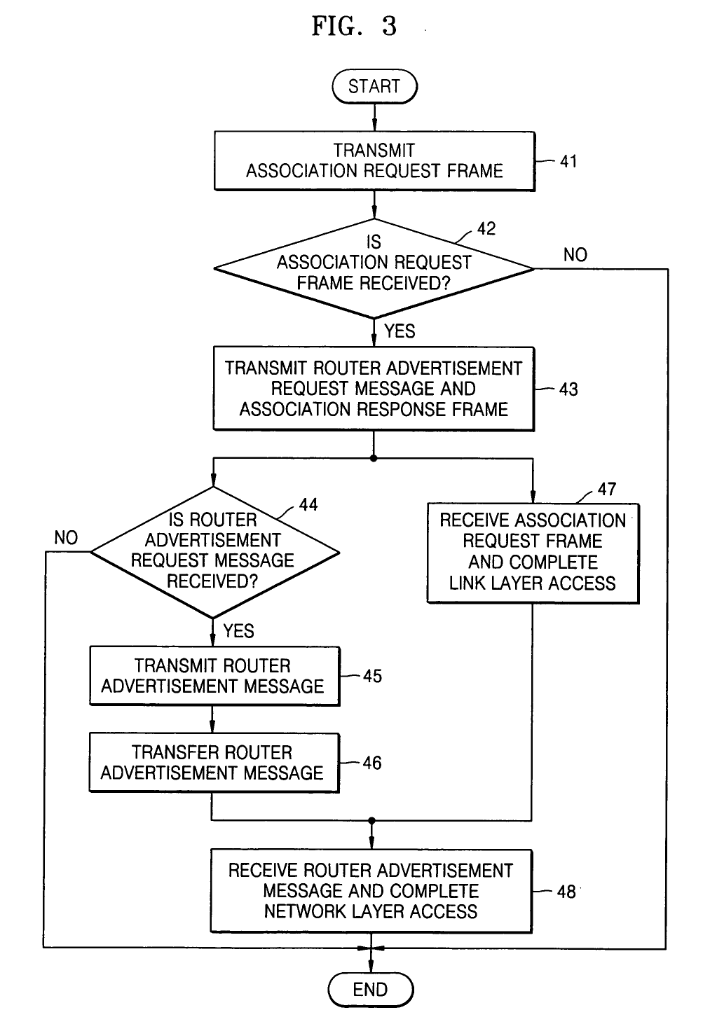

FIG. 3 is a flowchart of a method for fast connection to a link layer/network layer, according to an embodiment of the present invention.

Referring to FIG. 3, the method for fast connection to a link layer/network layer includes the following operations.

In operation 41, the mobile node 1 transmits an association request frame, requesting information for connection to the link layer of the wireless LAN to the access point 2.

Then, if the access point 2 receives the transmitted association request frame, in operation 42, a router advertisement request message requesting information for connection to the network layer of the wireless LAN is transmitted to the access router 3, and at the same time, an association response frame including information for connection to the link layer of the wireless LAN is transmitted to the mobile node 1, in operation 43.

Next, if the access router 3 receives the transmitted router advertisement request message, in operation 44, a router advertisement message is transmitted in operation 45.

Then, in operation 46, the access point 2 receives the transmitted router advertisement message and transmits the received router advertisement message.

Concurrently with the operations 44 through 46, in operation 47, the mobile node 1 receives the transmitted association response frame, and by using information included in the received association response frame, completes connection to the link layer of the wireless LAN.

Then, in operation 48, on the link layer in which the connection has been completed, the mobile node 1 receives a router advertisement message including information for connection to the network layer of the wireless LAN, and by using information included in the received router advertisement message, completes connection to the network layer of the wireless LAN. As described above, by generating a network layer address, as a new recognition mark of the mobile node 1 in the network layer, the mobile node 1 completes connection to the network layer of the wireless LAN.

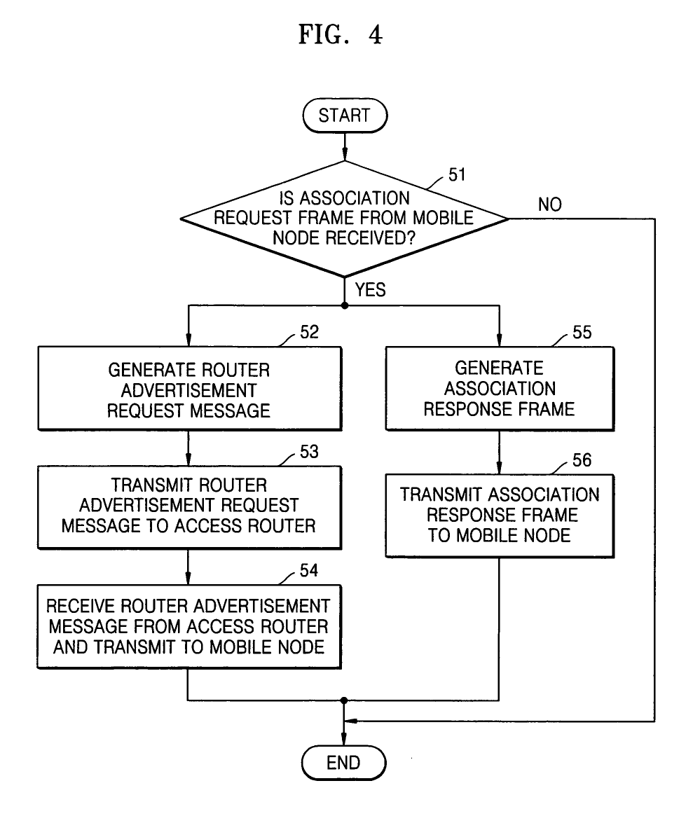

FIG. 4 is a flowchart of the operations performed by a method for relaying a wireless LAN and/or a wired network, according to an embodiment of the present invention.

Referring to FIG. 4, the method for relaying a wireless LAN and/or a wired network includes the following operations. The present embodiment can be performed in the access point 2, shown in FIG. 1.

If an association request frame requesting information for connection to the network layer of the wireless LAN from the mobile node 1 trying to establish a connection to the wireless LAN is received, in operation 51, and a router advertisement request message requesting information for connecting to the network layer of the wireless LAN is generated, in operation 52.

Then, in operation 53, the generated router advertisement request message is transmitted to the access router 3 connected to the wired network.

Then, in operation 54, as a response message to the transmitted router advertisement request message, a router advertisement message including information for connection to the network layer of the wireless LAN from the access router 3 is received, and the received router advertisement message is transmitted to the mobile node 1.

Concurrently with operations 52 through 54, the following operations 55 and 56 are performed.

If an association request frame requesting information, for connection to the network layer of the wireless LAN from the mobile node 1, is received in operation 51, an association response frame including information for connection to the link layer of the wireless LAN is generated in operation 55.

Then, the generated association response frame is transmitted to the mobile node 1, in operation 56.

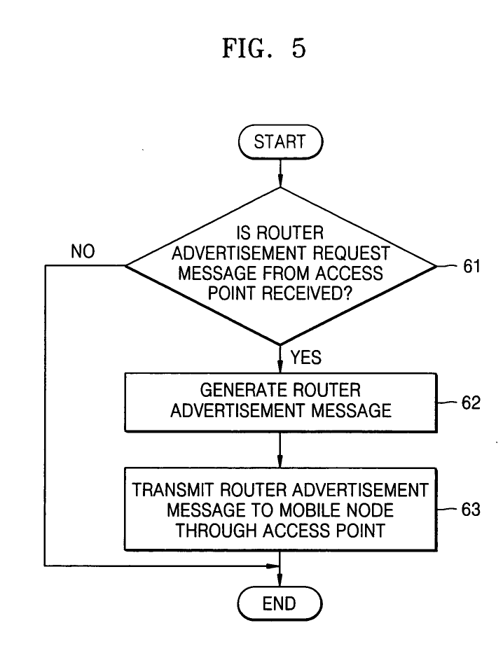

FIG. 5 is a flowchart of the operations performed by a wired network routing method, according to an embodiment of the present invention.

Referring to FIG. 5, the wired network routing method includes the following operations. The present embodiment is performed in the access router 3 shown in FIG. 1.

In operation 61, if the mobile node 1 receives a router advertisement request message, which is a message requesting information for connection to the network layer of the wireless LAN, from the access point 2 relaying the wireless LAN, to which the mobile node 1 is trying to establish a connection, and the wired network in operation 61, a router advertisement message is generated, in operation 62.

Then, in operation 63, the router advertisement message including information for connection to the network layer of the wireless LAN is transmitted to the mobile node 1 through the access point 2.

In addition to the above described embodiments, embodiments of the present invention can be implemented through computer readable code and implemented in general-use digital computers through use of a computer readable medium including the computer readable code. The computer readable medium can correspond to any medium/media permitting the storing or transmission of the computer readable code.

The structure of data used in the embodiments of the present invention described above can be recorded on a computer readable recording medium in a variety of ways. Examples of the computer readable medium may include magnetic storage media (e.g., ROM, floppy disks, hard disks, etc.), optical recording media (e.g., CD-ROMs, or DVDs), and storage media such as carrier waves (e.g., transmission through the Internet).

While embodiments of the present invention have been particularly shown and described with reference to exemplary embodiments thereof, it will be understood by those of ordinary skill in the art that various changes in form and details may be made therein without departing from the spirit and scope of the present invention as defined by the following claims. The discussed embodiments should be considered in a descriptive sense only and not for purposes of limitation. Therefore, the scope of the invention is defined not by the detailed description of the invention but by the appended claims, and all differences within the scope will be construed as being included in the present invention.

Accordingly, according to the present invention, by almost concurrently processing a connecting to a link layer and to a network layer of a wireless LAN, a high speed handover in the wireless LAN can be implemented and a separate link layer trigger protocol is not needed. That is, a mobile node can generate its network address more quickly according to embodiments of the present invention, such that even when the mobile node moves at a high speed between wireless LANs, the existing connection can be maintained.

Also, according to embodiments of the present invention, by defining a new message format, that is, a router advertisement request message, the mobile node can receive a router advertisement message more quickly. By doing so, the access point does not need to perform separate processes for transmission and reception of a router request message and a router advertisement message.

Again, although a few embodiments of the present invention have been shown and described, it would be appreciated by those skilled in the art that changes may be made in these embodiments without departing from the principles and spirit of the invention, the scope of which is defined in the claims and their equivalents.

1. A link layer/network layer access method, comprising:
transmitting a request message requesting information for connecting a mobile node and a network layer of a wireless LAN before completion of a connection of the mobile node and a link layer of the wireless LAN; and
completing connection of the mobile node to the network layer by using information included in a response message, transmitted in response to the transmitted request message.

2. The method of claim 1, wherein, unlike a router request solicitation message of an Internet Protocol version 6 (IPv6) standard which is capable of being requested only after the connection to the link layer is completed, the request message is capable of being requested before connection to the link layer is completed, and the response message is a router advertisement message of the IPv6 standard.

3. The method of claim 1, further comprising:
if the transmitted request message is received, transmitting a response message including information for connection to the network layer;
receiving the transmitted response message and transferring the received response message to the mobile node; and
completing connection to the network layer based on information included in the transmitted response message.

4. The method of claim 1, further comprising:
transmitting a request frame requesting information for connection to the link layer,
wherein in the transmitting of the request message requesting information for connecting a mobile node and the network layer, if the transmitted request frame is received, the request message is transmitted.

5. The method of claim 4, wherein in the transmitting of the request message requesting information for connecting a mobile node and the network layer a response frame, to the request message and the request frame, is transmitted, and
in completing connection to the network layer, by using information included in the transmitted response frame, connection to the link layer is completed and the response message is received.

6. The method of claim 5, wherein the request frame is an association request frame of an IEEE 802.11 standard, and the response frame is an association response frame of the IEEE 802.11 standard.

7. A link layer/network layer access apparatus, comprising:
an access point transmitting a request message requesting information for connecting a mobile node and a network layer of a wireless LAN, before connection of the mobile node and a link layer of the wireless LAN is completed; and
the mobile node completing connection to the network layer by using information included in a response message to the transmitted request message.

8. The apparatus of claim 7, wherein, unlike a router request solicitation message of an Internet Protocol version 6 (IPv6) standard which is capable of being requested only after connection to the link layer is completed, the request message is capable of being requested before connection to the link layer is completed, and the response message is a router advertisement message of the IPv6 standard.

9. A relay method, comprising:
transmitting a request message requesting information for connection of a mobile node to a network layer of a wireless LAN if a request frame, requesting information for connecting a mobile node and a link layer of the wireless LAN, is received; and
receiving a response message to the transmitted request message, and
transmitting the received response message to the mobile node.

10. The method of claim 9, wherein, unlike a router request solicitation message of an Internet Protocol version 6 (IPv6) standard which is capable of being requested only after connection to the link layer is completed, the request message is capable of being requested before connection to the link layer is completed, and the response message is a router advertisement message of the IPv6 standard.

11. The method of claim 9, further comprising:
transmitting a response frame, to the received request frame, to the mobile node if the request frame is received.

12. The method of claim 11, wherein the request frame is an association request frame of an IEEE 802.11 standard, and the response frame is an association response frame of the IEEE 802.11 standard.

13. An access point, comprising:
a request message transmission unit to, if a request frame requesting information for connecting a mobile node and a link layer of a wireless LAN is received, transmit a request message requesting information for connection to a network layer of the wireless LAN; and
a response message relay unit to receive a response message to the request message transmitted by the request message transmission unit, and transmit the received response message to the mobile node.

14. The access point of claim 13, wherein, unlike a router request solicitation message of an Internet Protocol version 6 (IPv6) standard which is capable of being requested only after connection to the link layer is completed, the request message is capable of being requested before connection to the link layer is completed, and the response message is a router advertisement message of the IPv6 standard.

15. A routing method, comprising:
receiving a request message from an access point requesting information for connecting a mobile node and a network layer of a wireless LAN; and
transmitting a response message, to the received request message, to the mobile node through the access point,
wherein the response message is transmitted from an access router before connection between the mobile node and a link layer of the wireless LAN is completed.

16. The routing method of claim 15, wherein, unlike a router request solicitation message of Internet Protocol version 6 (IPv6) standard which is capable of being requested only after connection to the link layer is completed, the request message is capable of being requested before connection to the link layer is completed, and the response message is a router advertisement message of the IPv6 standard.

17. An access router, comprising:
a request message reception unit to receive a request message from an access point requesting information for connecting a mobile node and a network layer of a wireless LAN; and
a router advertisement message transmission unit to transmit a response message, to the request message received by the request message reception unit, to the mobile node through the access point,
wherein the response message is transmitted from the access router before connection between the mobile node and the link layer of the wireless LAN is completed.

18. The access router of claim 17, wherein, unlike a router request solicitation message of an Internet Protocol version 6 (IPv6) standard which is capable of being requested only after connection to the link layer is completed, the request message is capable of being requested before connection to the link layer is completed, and the response message is a router advertisement message of the IPv6 standard.

19. The access router of claim 17, wherein the access router communicates with the access point through a wired network, and the access point and the mobile unit communicate through a wireless network.

20. A computer readable medium comprising computer readable code for a link layer/network layer access method, wherein the method comprises:
transmitting a request message requesting information for connecting a mobile node and a network layer of a wireless LAN before connection of the mobile node and the link layer of a wireless LAN is completed; and
completing connection of the mobile node to the network layer by using information included in a response message, transmitted in response to the transmitted request message.

21. A computer readable medium comprising computer readable code for a relay method, wherein the method comprises:
transmitting a request message requesting information for connection of a mobile node to a network layer of the wireless LAN if a request frame requesting information for connecting the mobile node and a link layer of a wireless LAN is received; and
receiving a response message to the transmitted request message, and
transmitting the received response message to the mobile node.

22. A computer readable medium comprising computer readable code for a routing method, wherein the method comprises:
receiving a request message from an access point requesting information for connecting a mobile node and a network layer of a wireless LAN; and
transmitting a response message to the received request message, to the mobile node through the access point, wherein the response message is transmitted from an access router before connection between the mobile node and the link layer of the wireless LAN is completed.

23. A mobile node in a wireless network, comprising:
a request frame transmission unit transmitting an association request frame requesting information for connecting the mobile node and a network layer of the wireless network;
a response frame reception unit to receive an association response frame responding to the association request frame including information for implementing a link layer access with the wireless network; and
a response message reception unit to receive a response message including information for implementing a network layer access with the wireless network, such that the response message may be generated and/or sent to the mobile node before implementation of the link layer access.
